(19) United States
(12) Patent Application Publication
(10) Pub. No.: US 2025/0036788 A1
(43) Pub. Date: Jan. 30, 2025

(54) METHOD FOR HANDLING DATA RELATING TO AN AGRICULTURAL MACHINE

(71) Applicants: KRONE AGRICULTURE SE, SPELLE (DE); LEMKEN GMBH & CO. KG, ALPEN (DE)

(72) Inventors: MATTHIAS MUETER, BONN (DE); CHRISTIAN LERCH, RHEINE (DE); SEBASTIAN ROETTGERMANN, KAPELLEN AN DER FLEUTH (GELDERN) (DE); STEFFEN WESTPHAL, MELLE (DE); DOMINIK SCHOOFS, UEDEM (DE)

(73) Assignees: KRONE AGRICULTURE SE, SPELLE (DE); LEMKEN GMBH & CO. KG, ALPEN (DE)

(21) Appl. No.: 18/777,562

(22) Filed: Jul. 19, 2024

(30) Foreign Application Priority Data
Jul. 24, 2023 (DE) 10 2023 119 507.7

(51) Int. Cl. G06F 21/62

(52) U.S. Cl. CPC G06F 21/62; G06F 2221/2141

(57) ABSTRACT

A method for handling data relating to an agricultural machine. The method includes enabling an access to the data relating to an operation of the agricultural machine via at least one user interface, and automatically determining on a person-specific basis which access is enabled for a specific person via a data system.

### CROSS REFERENCE TO PRIOR APPLICATIONS

Priority is claimed to German Patent Application No. DE 10 2023 119 507.7, filed Jul. 24, 2023. The entire disclosure of said application is incorporated by reference herein.

### FIELD

The present invention relates to a method for handling data relating to an agricultural machine, to a data system, and to an agricultural machine.

### BACKGROUND

Most modern agricultural machinery is either self-propelled with its own drive or is designed to be towed by a tractor. In addition to self-propelled vehicles that are controlled by a driver, autonomous vehicles will become increasingly important in the future in that they will control themselves at least some of the time during field operations without having to rely on driver input. The use of agricultural machinery and its current status can be described using various data. This includes operating parameters such as engine speeds or torques, but also data that corresponds to routes or yield maps, as well as parameters that indicate a malfunction, diagnostic data, etc. The respective data can, for example, be readable directly from the agricultural machine or via a temporarily connected terminal device. In addition to reading out data, some data can also be changed, i.e., overwritten. In order to rectify a malfunction, for example, a qualified person must have access to the relevant data. In many cases, this is not the person who is with the agricultural machine when the malfunction occurs, for example, the driver or user. This person may not even know who should be informed. A similar situation can also arise when a service workshop attempts to rectify a malfunction, but in some cases would have to involve the manufacturer. Irrespective of the occurrence of a malfunction and the relevant question of who must be informed and given access to certain data, it is also relevant to decide who may have access to certain data. This means that a particular person may and must have access to data that is essential for their task. Other data should be protected from being changed or even viewed by this person. Data relating to the steering system should, for example, at best be viewed by the user, but not changed, while data representing a yield map must be viewed (and changed if necessary) by the user, while the manufacturer or a service employee, for example, should not have access thereto.

### SUMMARY

An aspect of the present invention is to improve the handling of data relating to an agricultural machine.

In an embodiment, the present invention provides a method for handling data relating to an agricultural machine. The method includes enabling an access to the data relating to an operation of the agricultural machine via at least one user interface, and automatically determining on a person-specific basis which access is enabled for a specific person via a data system.

### BRIEF DESCRIPTION OF THE DRAWING

The present invention is described in greater detail below on the basis of embodiments and of the drawing in which:

FIG. 1 shows a schematic representation illustrating the processes involved in one embodiment of a method according to the present invention.

### DETAILED DESCRIPTION

The present invention provides a method for handling data relating to an agricultural machine, whereby access to data relating to the operation of the agricultural machine is enabled via at least one user interface.

Instead of data processing, i.e., the handling of data, one can also speak of data handling. This primarily involves making data accessible and protecting it. The term “data” here generally refers to information of any content that is usually stored and/or transmitted digitally. The agricultural machine can in principle be any type of machine that is usable for field processing. This applies both to a machine that performs the actual field cultivation, for example, a combine harvester, forage harvester, rake or similar, as well as a tractor that does not perform the field cultivation itself but pulls the corresponding processing machine as a trailer. The agricultural machine may have its own traction drive or may be intended to be towed.

The method enables access to data via at least one user interface. The user interface can be designed for data input and/or data output. The user interface can, for example, be a smartphone, a tablet, a laptop, or a desktop computer, but also a terminal device that has been specially designed for data access in connection with the agricultural machine. The data output can, for example, be visual, for example, on a screen, but acoustic data output is also conceivable, at least as a supplement. Access to data can in this context relate to reading and/or writing data.

More precisely, the present invention enables access to data related to the operation of the agricultural machine. The data can relate to the agricultural machine itself, for example, to its current operating status. This includes operating parameters such as engine speeds or torques, hydraulic or pneumatic pressure, current or voltage, etc. The data can also be parameters that correspond to a setting of the agricultural machine, for example, how sensitively a steering system reacts to steering commands. The data can also be parameters that indicate an operational fault, diagnostic data, etc. Data can in this context also correspond to a notification or message, for example, that a certain component of the agricultural machine has failed. The data need not relate directly to the agricultural machine. The data could also refer to the field or the working area the agricultural machine is used on, whereby the data could, for example, correspond to a yield map or to a route that the agricultural machine has traveled or is to travel.

The present invention accordingly provides that a data system automatically determines, on a person-specific basis, which access is enabled for a person. “Person-specific” means that the determination is made differently for different persons. In other words, the data system determines that different persons are given different access options. The above-mentioned user interface can be part of the data system but can also be permanently or temporarily connected to the data system without being part thereof. The data system can, for example, be implemented at least partially in hardware. The data system can, for example, be implemented at least partially in software. The data system can be implemented on and/or via physically connected hardware, or on a plurality of physically separate hardware components that can communicate with each other, for example, wirelessly.

The data can be stored in the data system itself, but the data can also be stored outside of the data system. The term “data system” should not thereby be interpreted to mean that the data system must contain the data. The term much rather indicates that the system determines access to the data. This means, for example, that the data system itself enables the access defined in this way so that access takes place via the data system. In a broader sense, however, it would also be conceivable that the data system merely provides the information as to which person should have which data access. Data is not in any case made fully accessible to every person, but to varying degrees depending on the person. This means that some people may not be given any access at all, while others may be given partial access, and still others may be given full access, whereby a differentiation between read and write access is possible and generally makes sense. It can be taken into account that certain people are not allowed or should not have access to certain data, and that certain data is not important for certain people and therefore need not to be made accessible. The actual access to the data can be linked to the person identifying themselves in any way, for example, via a password, a code, biometric parameters, or other measures known in the state of the art.

As mentioned above, the agricultural machine can be a tractor, a towed agricultural machine, or a self-propelled agricultural machine that also carries out field cultivation. The agricultural machine can in particular be an autonomous vehicle. This refers to a vehicle that steers itself at least some of the time during field processing without receiving steering commands from a person. Outside the field or working area, for example, when driving on the road, the vehicle can be steered manually, towed, or transported loaded onto another vehicle.

The data system can, for example, determine which access is granted to a person depending on whether that person belongs to a defined person category. Instead of a person category, one can generally also speak of a user category. The different categories of person can differ, for example, in the way they interact with the agricultural machine or in their expertise in relation to the agricultural machine. A distinction can in particular be made between user, owner, manufacturer and/or service employee with regard to the defined categories of persons. A user is the person who uses the agricultural machine on site in the field. This could, for example, be the driver of a tractor or a self-propelled field processing machine. This could also be the person who brings an autonomous vehicle to the field, activates it there and/or programs it to process a particular field. The user may not be the same as the owner, for example, because the user works for the owner or because the user has rented the agricultural machine from the owner. At least two of the above four categories of person are, for example, distinguished, or even all four. Additional categories of persons can also be distinguished.

An embodiment of the present invention provides that a person is given access to different data categories depending on their category of person. In other words, the person's affiliation of a person category determines which data category or data categories the person can access. A person who belongs to the person category “User” can, for example, gain access to a data category “Yield cards”, while said person cannot gain access to a data category “Steering system”. Conversely, a person belonging to the person category “Manufacturer” or “Service employee” can be granted access to the latter data category “Steering system”, while not being granted access to the data category “Yield cards”. Other data categories are also conceivable, for example, “Drive”, “Environment detection”, “Sensors”, etc.

A person can in particular be enabled to read out data and/or edit data depending on their category of person. This means that a distinction can be made between the category of person to which the person belongs, both in terms of reading out data and processing data. In the above example, a person in the “User” category could, for example, be able to read out data in the “Steering system” category, but not edit it. It would also be conceivable that a certain category of person can only read data without being able to edit any data.

An embodiment of the present invention enables improved handling of malfunctions of the agricultural machine. It is intended that an at least potentially imminent malfunction of the agricultural machine is recognized, a decision unit of the data system automatically makes a decision as to which person must be informed about the malfunction, and automatically makes data available to the person, via which the person is informed of the malfunction. A malfunction is here defined as any condition or event that impairs or prevents the operation of the agricultural machinery. An “at least potentially imminent malfunction” can be a currently existing malfunction or a malfunction that is certain or reasonably likely to occur if no action would be taken. This may be the case, for example, if an operating parameter of the agricultural machine is still within a permissible range but shows unusual fluctuations or other deviations from a standard value. If a component's wear or a low residual level of an operating fluid is detected, an imminent malfunction could also be expected. A decision unit of the data system automatically decides which person or persons need to be informed. This in particular involves at least one person who is qualified to rectify the current malfunction or prevent the imminent malfunction. However, it would also be possible, for example, for a manufacturer to be informed without being involved in rectifying the malfunction, for example, in order to be informed about the frequency with which a particular malfunction occurs on a particular agricultural machine. The decision unit is part of the data system and can be implemented entirely in software. The decision can be made on the basis of data about the malfunction, for example, using a look-up table, or for example, using artificial intelligence. The decision unit automatically provides that the at least one person to be informed with data that informs them about the malfunction. The corresponding data can be more or less extensive, detailed and/or specific. In the simplest case, the data could merely contain the information that a malfunction is present or potentially imminent. The data can, for example, describe at least the type of malfunction, for example, which part of the agricultural machine is affected, which parameter deviates from a target value or target range, etc. The decision unit can make the data accessible in so that it outputs the data directly on a user interface that is directly accessible to the person. A notice could also be issued on the user interface indicating that the data is accessible. Actual access to the data could be linked to an identification of the person. Under certain circumstances, however, this can be waived if it is clear from the circumstances that only the person in question has access to the user interface.

An embodiment of the present invention provides that the decision is made by a decision unit implemented on the agricultural machine. This means that a hardware, which at least partially forms the decision unit, and/or a hardware on which a software representing the decision unit runs, is arranged within the agricultural machine. Another embodiment of the present invention provides that the decision is made by a decision unit which is external to the agricultural machine. In other words, hardware of the decision unit and/or hardware on which the software of the decision unit runs is arranged outside the agricultural machine. The decision unit can, for example, be implemented on a PC, a tablet, or a smartphone. The entire data system can be implemented at the same location as the decision unit, while other parts of the data system can also be implemented at a different location.

Even if the decision as to which persons are informed is made automatically, the malfunction can be detected in different ways. One embodiment provides that the at least potentially imminent malfunction is automatically detected by a malfunction detection unit of the agricultural machine. According to another embodiment, the malfunction is automatically detected by a malfunction detection unit which is external to the agricultural machine. In both cases, the fault detection unit can be implemented in hardware and/or software. It can be part of the data system, but it can also be independent thereof in terms of hardware and/or software. In the latter case, it is advantageous if the fault detection unit transmits data relating to the operational fault to the decision unit of the data system. Yet another embodiment provides for the at least potentially imminent malfunction to be recognized by a person. The person can in this case enter data into the data system that corresponds to the malfunction. This data can then form the basis for the decision of the decision unit.

An embodiment of the present invention provides that, depending on the malfunction, the data system automatically decides that at least one action is to be taken by the person in order to counteract the malfunction, and the data system makes data available to the person informing them of the action to be taken. The data can in turn be output to a user interface that is accessible to the respective person. The decision on which action to take can, for example, also be made by the above-mentioned decision unit. In this case, the decision can also be made, for example, using a look-up table or artificial intelligence. Either the action can serve to prevent a potentially imminent malfunction or to eliminate an existing malfunction.

Apart from a specific instruction for action, the data system can provide the person with information material which is tailored to the malfunction. The information material can be in text form, in image form and/or in acoustic form. It can also, for example, be a movie. The information material can, for example, contain general information that is thematically related to the operational fault. If there is a malfunction in a drive unit, for example, the information material could contain general explanations of the design and function of the drive unit as well as a reference to known sources of error.

The data system can itself also contain information material which is made accessible to the person. Alternatively or additionally, however, the data system can also make information material accessible from a database which is external to the data system. If the data system is connected to a network, in particular to the Internet, corresponding information material can, for example, be linked.

The data system can also have a diagnostic unit. This is usually implemented in software. A person can make a request to the diagnostic unit via a user interface and receive a response. The response can, for example, be an error code that at least allows the type and/or cause of the malfunction to be narrowed down and, ideally, precisely determined.

A person can, for example, be given remote access to the data. Remote access is access via a user interface that is remote from the agricultural machine and/or the data system. A connection to the user interface can be established via a wired and/or wireless network. Remote access makes it possible, for example, for a service employee or a manufacturer to view (and possibly edit) relevant data without having to be on site. Such remote access can replace or precede an on-site presence. If a malfunction needs to be rectified, this of course need not be performed in the field or on the premises of the user or owner, but the agricultural machine can also be transported to a service workshop or to the manufacturer. Even in these cases, however, it may be advantageous if data can be read and, if necessary, processed in advance.

An embodiment of the present invention provides that access to data be given for at least two persons of different categories in the event of an at least potentially imminent malfunction, with at least one of the persons accessing the data via remote access. Both persons can in this case participate in the analysis and in the elimination of the malfunction and coordinate their efforts. An example would be that one person is a user who is in the immediate vicinity of the agricultural machine, while another person may be a service employee who accesses the data remotely via a network. The persons can of course also communicate with each other. This can either be done via a connection independent of the data system, for example, by the persons talking to each other on the phone, or the data system can support corresponding communication via an embedded chat, voice function, or video function. The persons can also be supported by the abovementioned diagnostic unit. The decision unit can decide which people must have access. It can also give each of the persons an indication that it makes sense to involve the other person(s) in the present malfunction.

The present invention also provides a data system for handling data relating to an agricultural machine. The data system is set up to enable access to data relating to the operation of the agricultural machine via at least one user interface. The present invention provides that the data system is set up to enable access on a person-specific basis.

Advantageous embodiments of the data system according to the present invention correspond to those of the method according to the present invention.

The present invention also provides an agricultural machine with a data system. The data system is set up to enable access to data associated with the operation of the agricultural machine via at least one user interface. The present invention provides that the data system is set up to enable access on a person-specific basis.

Advantageous embodiments of the agricultural machine according to the present invention correspond to those of the method according to the present invention.

The present invention is described below with reference to drawing. The drawing is merely exemplary and does not limit the general idea of the present invention.

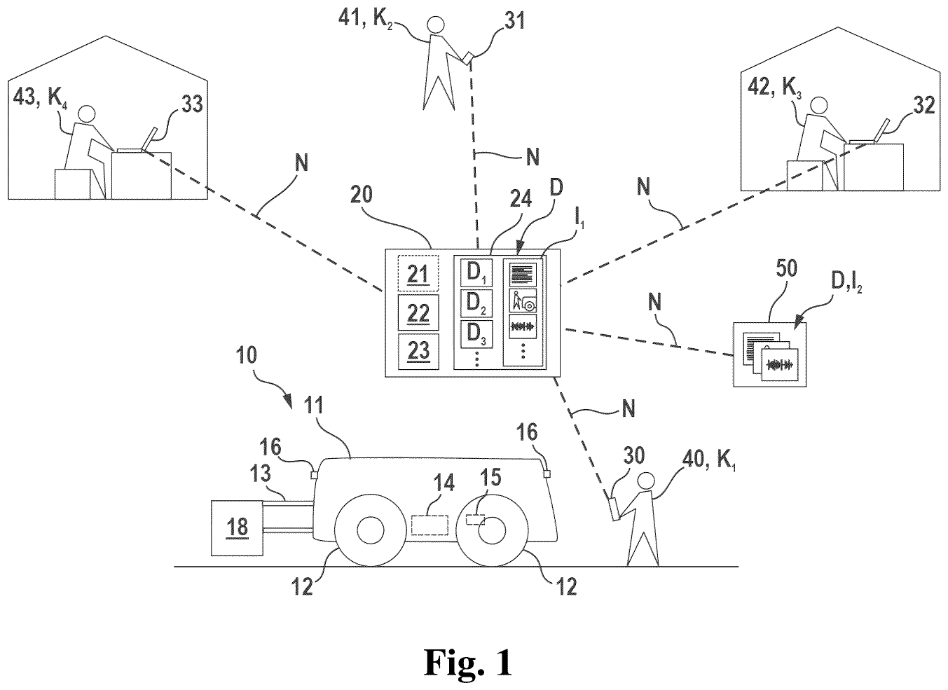

FIG. 1 shows an agricultural machine 10, in this case an autonomous vehicle, which has a vehicle body 11 with a chassis 12 arranged thereon and a lifting gear 13, to which various attachments 18 can be coupled. The attachment 18 indicated here purely schematically can, for example, be a mower. The agricultural machine 10 has a drive 14, which is shown here as a single block, although separate drive units can be provided for each of the two axles of the chassis 12 and for a PTO shaft, via which the attachment 18 is driven. A steering system 15 is also shown, via which a steerable axle of the chassis 12 can be adjusted. Both axles could also be steerable. The agricultural machine 10 also has sensors 16 which are primarily used to detect the surroundings of the agricultural machine 10. These can, for example, be ultrasonic sensors, radar sensors, lidar sensors and/or camera sensors.

A data system 20 is associated with the agricultural machine 10, which may be implemented wholly or partly in the agricultural machine 10 itself, but which may also be wholly or partly an external system with respect to the agricultural machine 10. The data system 20 has a memory 24 with data D. The data system 20 can also implement various control structures. The data system 20 has a decision unit 22, a diagnostic unit 23, and optionally a malfunction detection unit 21. The malfunction detection unit 21 (if present) recognizes whether an operational fault of the agricultural machine 10 is present or whether such an operational fault is potentially imminent. For this purpose, the malfunction detection unit 21 can query various operating parameters of the individual systems of the agricultural machine 10, for example, speeds, torques, a pressure of an operating fluid, etc. The malfunction can also be detected automatically by an external unit or by a person 40-43. If a malfunction is detected, the decision unit 22 is informed thereof, in the present example automatically by the malfunction detection unit 21. The decision unit 22 then automatically decides which persons 40-43 are to be informed of the malfunction and may access the data D relating thereto. The decision can be made on the basis of data D about the malfunction, for example, via a look-up table or, for example, via artificial intelligence. In the example in FIG. 1, four persons 40-43 are shown who belong to different categories of persons K₁-K₄. One user 40 belongs to a first category of person K₁ and is in the immediate vicinity of the agricultural machine 10. Person K₁ can retrieve or enter data D via a mobile first user interface 30, for example, a tablet. An owner 41 of the agricultural machine 10, who belongs to a second category of person K₂, is not in the vicinity. Person K₂ can access data D via a mobile second user interface 31, for example, a smartphone. A service employee belonging to a third category of person K₃ can also access data D via a third user interface 32, for example, a laptop or desktop computer. Finally, a manufacturer belonging to a fourth category of person K₄ can access data D via a fourth user interface 33, which may also be a laptop or desktop computer. The respective user interfaces 30-33 are connected to the data system 20 via a schematically indicated network N, for example, the Internet.

In the event of a malfunction, but also independently thereof, the data system 20 determines which person 40-43 can access which data D, depending on the person category K₁-K₄. For each person category K₁-K₄, it can be determined whether the respective person 40-43 can access data D as a whole or individual data categories D-D₁₃. A distinction can in turn be made between reading data D and changing data D. For example, the user 40 can be given access to a first data category D₁, in which yield maps are stored, while user 40 is not given access to a second data category D₂, which relates to the steering system 15. Conversely, the manufacturer 43 or the service employee 42 can obtain access to the second data category D₂ or to a third data category D₃, which is assigned to the drive 14, while they do not obtain access to the first data category D₁.

In the present case, the decision unit 22 decides that all four persons 40-43 are given access to data D, which informs them of the malfunction. For its part, the data system 20 can actively send a notification to the respective user interface 30-33. It is not initially intended that the manufacturer 43 or the owner 41 will be involved in the removal of the malfunction. The manufacturer 43 receives data D about the affected agricultural machine 10, the affected system, and data D that characterize the malfunction in more detail, including, if applicable, diagnostic data supplied by the diagnostic unit 23. It can use this data D for statistical purposes, for example, to identify components that are particularly susceptible to malfunctions and to improve them in the future. The owner 41 receives data D that informs the owner 41 about the affected agricultural machine 10 and the affected system. If necessary, the owner 41 can also receive data D that characterizes the malfunction in more detail. It is conceivable that the owner 41 can also authorize a repair via the connection with the data system 20.

The user 40, who is on site at the agricultural machine 10, has access to data D that characterizes the affected system and the malfunction, and the user 40 can also view diagnostic data if necessary. Via the first user interface 30, for example, the user 40 can also send data D to the diagnostic unit 23, whereupon the latter in turn outputs diagnostic data (for example, an error code or the like). Depending on the malfunction, the data system 20 can also automatically decide that at least one action can be taken by the user 40 to counteract the malfunction and can make data D available to the user 40, informing the user 40 of the action to be taken. This may be in the form of text, sound and/or image data output via the first user interface 30. Apart from a specific instruction, information material I₁, I₂ can also be provided which is related to the malfunction and which helps the user 40 to understand the affected system and, for example, provides information about known sources of error. This information material I₁, I₂ can also be provided in text, audio and/or image form, for example, as a podcast or video file. Both information material I₁ from the memory 24 of the data system 20 and information material 12 from an external database 50, for example, a server to which the data system 20 is connected via the network N, can be included. The user 40 is in many cases not able to eliminate the malfunction despite the possible assistance provided by the data system 20. This may be related in particular to the user's 40 generally insufficient familiarity with the systems of the agricultural machine 10. Due to this lack of knowledge, the data system 20 also prevents the user 40 from being able to change data D relating to the steering system 15 or the drive 14, for example, i.e., data D from the second data category D₂ or the third data category D₃. The user 40 at best has reader access to this data.

In order to support the user 40 or to completely relieve the user 40 of the further analysis and elimination of the malfunction, the data system 20 also informs the service employee 42, who is given access to data D that characterizes the affected system and the malfunction. The service employee 42 can in particular send a request to the diagnostic unit 23 via the service employee's 42 third user interface 32, whereupon the latter provides the service employee 42 with diagnostic data. This diagnostic data can be used, for example, to prepare for an upcoming repair. The service employee 42 can also coordinate with the user 30, for example, by asking questions or by providing instructions. The corresponding communication can take place via the data system 20, which can enable chat, voice and/or video communication for this purpose. Communication can also take place, however, independently of the data system 20, for example, via a voice call or video call between the first user interface 30 and the third user interface 32. The service employee 42 can also access internal information material I₁ of the data system 20, as well as information material 12 from the external database 50. Since the service employee 42 has better relevant knowledge than the user 40, the data system 20 enables the service employee 42 to both read and process data D from the second data category D₂ and the third data category D₃. The service employee 42 can, however, neither read nor edit data D from the first data category D₁ which contains the yield maps. This data, which concerns the yield maps, is irrelevant for the service employee's 42 task and is not disclosed to for data protection reasons.

The present invention is not limited to embodiments described herein; reference should be had to the appended claims.

### LIST OF REFERENCE CHARACTERS

10 Agricultural machine
11 Vehicle body
12 Chassis
13 Lifting gear
14 Drive
15 Steering system
16 Sensor
18 Attachment
20 Data system
21 Malfunction detection unit
22 Decision unit
23 Diagnostic unit
24 Memory
30-33 User Interface
40 User
41 Owner
42 Service employee
43 Manufacturer
50 External database
D Data
D₁-D₃ Data category
I₁, I₂ Information material
K₁-K₄ Person category
N Network

What is claimed is:

1-16. (canceled)

17: A method for handling data relating to an agricultural machine, the method comprising:
enabling an access to the data relating to an operation of the agricultural machine via at least one user interface; and
automatically determining on a person-specific basis which access is enabled for a specific person via a data system.

18: The method as recited in claim 17, wherein the agricultural machine is an autonomous vehicle.

19: The method as recited in claim 17, wherein the automatically determining on the person-specific basis which access is enabled for the specific person via the data system is dependent on an affiliation of the specific person in a defined category of persons.

20: The method as recited in claim 19, further comprising:
distinguishing between at least one of a user, an owner, a manufacturer, and a service employee with regard to the defined category of persons.

21: The method as recited in claim 19, further comprising:
enabling access of the specific person to different data categories depending on the defined category of persons of the specific person.

22: The method as recited in claim 21, further comprising:
enabling the specific person to at least one of read out data and to process data depending on the defined category of persons of the specific person.

23: The method as recited in claim 19, wherein,
the data system comprises a decision unit, and
further comprising:
detecting an at least potentially imminent operational malfunction of the agricultural machine,
automatically deciding via the decision unit of the data system as to which specific person must be informed of the at least potentially imminent operational malfunction, and
automatically making data accessible to the specific person so as to inform the specific person of the at least potentially imminent operational malfunction.

24: The method as recited in claim 23, wherein,
the decision unit of the data system is implemented on the agricultural machine, or
the decision unit of the data system is implemented external to the agricultural machine, and
the automatic deciding via the decision unit of the data system is performed via the decision unit which is implemented on the agricultural machine or via the decision unit which is external to the agricultural machine.

25: The method as recited in claim 23, wherein,
the data system further comprises a malfunction detection unit which is implemented on the agricultural machine or which is implemented external to the agricultural machine, and
further comprising:
automatically detecting the at least potentially imminent operational malfunction of the agricultural machine via the malfunction detection unit which is implemented on the agricultural machine, or
automatically detecting the at least potentially imminent operational malfunction of the agricultural machine via the malfunction detection unit which is external to the agricultural machine, or
detecting the at least potentially imminent operational malfunction of the agricultural machine by a person.

26: The method as recited in claim 23, further comprising:
automatically deciding via the data system, depending on an operational disturbance, that at least one action must be taken by the specific person in order to counteract the operational disturbance; and
making data available to the specific person so as to inform the specific person of the at least one action to be taken.

27: The method as recited in claim 23, further comprising:
making assessable information material which is adapted to the at least potentially imminent operational malfunction to the specific person via the data system.

28: The method as recited in claim 27, wherein information material is made accessible from a database which is external to the data system.

29: The method as recited in claim 23, further comprising:
enabling the specific person to remotely access the data.

30: The method as recited in claim 23, further comprising:
enabling access to at least two persons of the defined category of persons to the data in the event of the at least potentially imminent malfunction,
wherein,
at least one of the at least two persons is enabled access to the data via a remote access.

31: A data system for handling data relating to an agricultural machine,
wherein,
the data system is set up to enable access to the data relating to the operation of the agricultural machine via at least one user interface, and
the data system is set up to enable the access on a person-specific basis.

32: An agricultural machine comprising:
a data system which is set up to enable access to data which is associated with an operation of the agricultural machine via at least one user interface,
wherein
the data system is set up to enable the access on a person-specific basis.
